(19) United States
(12) Patent Application Publication
(10) Pub. No.: US 2018/0126419 A1
(43) Pub. Date: May 10, 2018

(54) VIBRATING APPARATUS AND METHOD OF IMPROVING THE DURABILITY OF A VIBRATING APPARATUS

(71) Applicant: GEA Scan-Vibro A/S, Svendborg (DK)

(72) Inventor: Karsten Ellehuus, Svendborg (DK)

(73) Assignee: GEA Scan-Vibro A/S, Svendborg (DK)

(21) Appl. No.: 15/575,814

(22) PCT Filed: May 26, 2016
(86) PCT No.: PCT/EP2016/061951

§ 371 Date: Nov. 21, 2017

(30) Foreign Application Priority Data
May 27, 2015 (EP) 15169477.5

(51) Int. Cl. B07B 1/46; B21D 28/26; B65D 90/10; B07B 1/50

(52) U.S. Cl. CPC B07B 1/4618; B21D 28/26; B07B 2201/02; B07B 1/50; B65D 90/10

(57) ABSTRACT

The vibrating apparatus has a housing (1) with a wall (2) provided with at least one aperture (3). A peripheral flange (4) protrudes from the wall (2) at the aperture (3) and has a plane surface (5) for abutment of a covering. The peripheral flange (4) is formed as an integral part of the wall (2), for instance by sheet metal forming, such as drawing, pressing, pulling, rolling and/or punching.

### FIELD OF THE INVENTION

The present invention relates to a vibrating apparatus comprising a housing including at least one wall provided with at least one aperture having a centre axis, a peripheral flange which protrudes from said wall at said aperture and is configured to cooperate with a covering, wherein the peripheral flange includes a plane surface for abutment of the covering, said plane surface extending in a plane, said centre axis being perpendicular to said plane. The invention furthermore relates to a method for improving the durability of a vibrating apparatus.

### BACKGROUND OF THE INVENTION

Vibrating apparatuses such as vibrating sieve apparatuses, vibrating screen sifters or vibrating fluid beds, are well known in the art for separating and classifying a material into at least two size-fractions by allowing the smaller fraction of the feed material to sift through a screen mesh, and for processing a particulate material by allowing a process gas to flow through a bed of material to be processed.

Vibration technology of this kind puts a great demand on the material used because of the stress applied to the material from the vibration of the apparatuses. Therefore vibrating apparatus are often made from a metal such as stainless steel; to be able to withstand such vibration stress meanwhile having a good resistance and inertness against a wide variety of powders and minerals. Thus, vibrating apparatus of this kind may be easier to clean and maintain.

Continuous vibrations from the apparatus operations can over time, in the worst case make a part of the vibrating apparatus housing break down causing an unplanned downtime resulting in inefficient operations and higher production costs. Some elements of a vibrating apparatus are especially at risk of breaking down due to vibration fatigue because of the continuous vibrating operations. These elements would often be elements which are attached to the metal housing of the vibrating apparatus.

A particularly interesting example is the inspection covers of a vibrating apparatus, which are connected to the housing in order to provide means for inspection and easier cleaning/maintenance of a vibrating apparatus, apart from what may be done with a cleaning in place (CIP) procedure.

A representative prior art sifter screen apparatus is shown and described in U.S. Pat. No. 4,287,056. The lower parts of this apparatus are assembled by welding to form a frame on top of which a sifter frame assembly is mounted by means of isolators comprising steel coil springs supporting the sifter assembly to enable the sifter frame assembly to float freely. Inspection ports are provided in a top wall of the sifter frame assembly.

Typically, inspection ports are provided as a cylindrical pipe stub welded to a wall of the apparatus on top of which a covering in the form of an inspection cover is placed.

In order to provide a larger abutment area between the covering itself and the cylindrical pipe stub constituting the inspection port, one commonly known solution is to provide a durable cover frame for an inspection cover by welding a peripheral flange of a cross-sectionally L-shaped configuration to an aperture of the housing of a vibrating apparatus thus providing a sealing surface for the inspection cover. Such welding operations are rather simple and cheap for a person skilled in the art and are therefore used in most modern vibrating apparatuses. However, one problem with this solution is that welds in vibrating apparatuses result in high stress concentrations in the material of the weld. Hence, the weld is more sensitive and the durability of the vibrating apparatus is dependent on the weld. Further, the stresses resulting from welding are known to deform or warp a metal sheet, particularly when the sheet is made of stainless steel.

Also the interfaces between the housing and the welds are subject to stress and are therefore vulnerable as well.

Thermal stress due to differences in thermal expansion coefficients in the welding and wall materials can cause problems in the event of sifting hot materials or if used in a hot environment.

Another problem with welds in vibrating apparatuses is that the sensitive areas of the housing will often need to be reinforced or stiffened, in order to prevent harmonic vibrations, which will further increase the wear on the housing. However it becomes problematic for the engineer to predict the harmonic frequencies of a housing region, once welding is present, as few accurate methods exist for predicting welds harmonic frequencies. As such, the placement of reinforcements and stiffeners becomes a guessing game, and will often lead to an excess of reinforcement.

Yet another issue with welds in cover frames for vibrating apparatuses arises when used for processing food, dairy and pharma products. Here hygiene is of high importance, and welds present a large number of creases and even micro cracks, which can become difficult to clean and as a result can lead to contamination of the product.

### SUMMARY OF THE INVENTION

From this background, it is an object of the present invention to provide a vibrating apparatus, by which the above disadvantages are alleviated and in which an improved durable vibrating apparatus is provided.

In a first aspect this and further objects are met by a vibrating apparatus of the kind mentioned in the introduction which is furthermore characterized in that the peripheral flange is formed as an integral part of said wall and from the wall material itself.

With a vibrating apparatus of this kind it is possible to provide a more durable vibrating apparatus that eliminates the need for welds or bolts when providing a peripheral flange constituting a cover frame for a covering such as an inspection cover. Stresses resulting from welding or thermal or mechanical effects and the associated deformation are to a large extent avoided. The deformations and warping caused by welding of sheet metal, especially near and/or around apertures, can be largely be avoided by having the flange as an integrated part of the wall. Further, the integration of the peripheral flange with the at least one wall provides the vibrating apparatus with stress resistant properties, in that the stress resulting from the vibrations applied to the vibrating apparatus is taken up in the entire construction of the wall, in which no extra welds substantially are present which would be in the risk of breaking during the applied stress from the vibrating process. Within the meaning of “integral part of” it should be understood that the flanges are made in one piece with the material of the remaining of the wall. Furthermore the forming of the peripheral flange will give the wall which is provided with an aperture an increased stiffness, such that vibrations will not have as large effect.

Further by having the flange as an integral part of the wall, estimation of the resonance frequencies of the different sections of the wall are simpler. Thus a more efficient design process is achieved, when calculating the required dimensions and reinforcements of the wall.

In a further embodiment this cover frame may also be used for elements attached to the metal housing such as an inlet element or discharge element.

In a further embodiment of the vibrating apparatus, said peripheral flange has been formed by sheet metal forming, such as drawing, pressing, pulling, rolling and/or punching. By applying such metal sheet forming it is possible to utilize the advantages of the present invention without adding extra costs on manufacturing or use more expensive knowledge intensive labour. Furthermore, with using such metal sheet forming methods, the at least one wall will be provided with a body having less stress concentrations than when using the typical manufacturing methods. Another advantage of using metal sheet forming is a reduction in micro cracks which can lead to hygiene problems when product adheres to the surfaces. This is an advantage when processing food, dairy and pharma products.

In one embodiment of the vibrating apparatus the peripheral flange has a thickness of at least 2 mm, preferably at least 3 mm and even more preferably at least 4 mm. Having a high thickness will improve the durability and strength of the peripheral flange constituting the cover frame and hence the durability of the entire vibrating apparatus.

In a further embodiment of the vibrating apparatus, said wall has a thickness of at least 2 mm, preferably at least 3 mm and even more preferably at least 4 mm. With a thickness of this kind it is possible to provide a housing which can withstand the high vibrational force in the vibrating apparatus.

In an embodiment of the invention, a vibrating apparatus has been provided with a peripheral flange, which has been formed from said wall without adding material to said wall. As such, the added stress concentrations from adding material can be reduced, as well as minimizing sensitivities in material from arising during the forming of the peripheral flanges. This will further help keeping the material cost down and eliminating further process steps.

In another embodiment of the vibrating apparatus, the peripheral flange has a reduction in thickness compared to the wall it is formed from, of less than 10%. By maintaining a relatively uniform thickness, sensitive areas, due to the vibration of the vibrating apparatus, are minimized.

In a further embodiment of the vibrating apparatus, the peripheral flange has a plane surface, which has a width of at least 4 mm, preferably at least 7 mm, and even more preferably at least 10 mm. By providing a plane surface of this kind, a gasket and a cover can be installed without any risk of the gasket slipping of the plane surface, which in turn reduces the risk of any unplanned down time of the vibrating apparatus.

In one embodiment of the vibrating apparatus, the aperture has a shape of the group: round, elliptical, square, and rectangular. From this it is clear that the aperture can be shaped in any form and thereby be connected to elements such as closings varying in shape and sizes or flexible tubes and still utilize the advantages of the present invention.

In one embodiment of the vibrating apparatus, the wall from which the offset peripheral flange is formed, is plane parallel to the plane surface of the flange. In another embodiment of the vibrating apparatus, the wall from which the offset peripheral flange is formed, is plane at an angle to the plane surface of the flange. And in yet another embodiment of the vibrating apparatus, the wall from which the offset peripheral flange is formed, is curved.

In an embodiment of the invention, the aperture of the vibrating apparatus has a minimum opening, measured as the distance from one point on the peripheral flange through the centre point of the aperture to another point on the peripheral flange, said minimum opening being at least 100 mm, more preferably at least 200 mm and even more preferably at least 400 mm. It is even conceivable to have an aperture of 500 mm in the minimum opening. Such large apertures are advantageous for inspection apertures, feed apertures and other similar apertures, and such large apertures will be sensitive to vibrations unless reinforced, which will normally be done by adding material by welding, bolting or riveting. The deformations and warping caused by welding of sheet metal, especially near and/or around apertures, is even more critical when the apertures are large. As such, the integration of the peripheral flange is even more advantageous, when applied around large apertures.

In another embodiment of the vibrating apparatus, the peripheral flange has an extension, such that the plane surface of the peripheral flange is offset from the wall in a direction along the centre axis of the aperture, by at least 3 mm, preferably at least 6 mm and even more preferably at least 9 mm. By providing a protrusion of this kind, a gasket and a cover can be installed with a cover extending beyond the gasket seal. It is to be understood that the dimensions of the peripheral flange may be adapted in accordance with the desired minimum opening of the aperture.

The choice of material for manufacturing a vibrating apparatus is very important since the material should be the most suitable for vibrating conditions, and resistant towards chemical exposure and mechanical impact from various pharmaceutical, food powders or minerals. According to the present invention the vibrating apparatus is made from a metal, which could be iron, steel, or preferably stainless steel, and even more preferably steel from AISI standard AISI 304 or AISI 316.

In an embodiment the vibrating apparatus further comprises a perforated element for allowing passage of material or gas such as air.

In a further embodiment, the vibrating apparatus is a vibrating sieve apparatus or a vibrating fluid bed.

In a further embodiment, the vibrating apparatus is used for processing of particulate material, and in an even further embodiment, for processing products belonging to the group: dairy, food or pharma products.

In a second aspect of the invention a method is provided for improving the durability of a vibrating apparatus by forming a cover frame in a wall of the housing of the vibrating apparatus, said method comprising the steps of:

A. providing a sheet of metal for a housing wall part,

B. placing said sheet of metal in a press form, by placing a target section of the sheet of metal in a recess of a bottom part of the form,

C. pressing the top part of the form by mechanical means to form an offset plane surface,

the method further comprising the step of cutting an aperture in said target section of the sheet of metal, by drilling, punching, sawing, cutting, milling of lathing or other like methods, following any of the steps, thus providing the aperture with an offset peripheral flange bordering the aperture, once all steps have been performed.

A vibrating apparatus provided by this method will have the advantages set up as described above in the first aspect of the invention.

In an embodiment, where the aperture is cut directly following step A, an easy cut can be made, however the forming of the offset peripheral flange becomes more demanding. In another embodiment, the aperture is cut after the target section has been offset. This allows for a more precise cut, however the cut will also become more difficult to make.

In a specific embodiment, where the aperture is cut after step A, the aperture dimensions are cut up to 5 mm smaller than the desired aperture dimensions at the end of the method. This is done, as the aperture expands during the offsetting of the target zone.

In another embodiment, an aperture may be cut in two or more steps, either successively or in steps separated by one or more of steps A-C. In a specific embodiment, a first aperture is cut in the target section of the sheet of metal following step A. After step C, a second aperture is cut around the first aperture. This is done in order to achieve a more precise cut of the aperture, by cutting it in two steps. In another embodiment, the first aperture is grinded following step C, instead of a second cut, for a more precise aperture.

In another embodiment, the sheet of metal provided in step A is at least 300 mm by 300 mm, in order to form apertures of up to 250 mm. For larger apertures, larger sheets are needed.

In a specific embodiment, a plate is fastened to the sheet of metal and the bottom part of the form. In a further embodiment, a top part of the form is fastened to the plate and the bottom part of the form.

In yet another embodiment, the sheet of metal has a thickness of at least 2 mm, preferably at least 3 mm and even more preferably at least 4 mm.

In yet another embodiment, the aperture is cut in a shape chosen from the group of geometrical shapes including round, elliptical, square, and rectangular.

In another embodiment, the aperture is cut with a minimum opening, measured as the distance from one point on the peripheral flange through the centre point of the aperture to another point on the peripheral flange, said minimum opening being at least 100 mm, more preferably at least 200 mm and even more preferably at least 400 mm. It is even conceivable to have cut an aperture of 500 mm in the minimum opening.

In yet another embodiment, the peripheral flange is formed such that the plane surface of the peripheral flange during is offset from the wall in a direction along the first plane from the transition point, by at least 3 mm, preferably at least 6 mm and even more preferably at least 9 mm. It is within in the general concept of the invention that the plane surface, peripheral flange, aperture, and the sheet of metal may have the same technical features in the first and the second aspect of the present invention.

Further details and advantages appear from the remaining dependent claims, and from the detailed description of preferred embodiments and examples for carrying out the method set forth below.

### BRIEF DESCRIPTION OF THE DRAWINGS

In the following the invention will be described in further details with reference to the accompanying drawings, where

FIG. 1 shows a perspective view of a vibrating apparatus known from prior art.

FIG. 2 shows a side view of a vibrating apparatus in an embodiment of the invention.

FIG. 3 shows a perspective view of a wall portion of a vibrating apparatus in an embodiment of the invention;

FIG. 4 shows a partial cross-sectional view of a wall portion of the detail of the vibrating apparatus in the embodiment of FIG. 3;

FIG. 5 shows a partial cross-sectional side view, on a larger scale, of a wall portion of the vibrating apparatus in the embodiment of FIG. 3;

FIG. 6 is a view corresponding to FIG. 3 of a wall portion of a vibrating apparatus in another embodiment of the invention; and

FIG. 7 is a view of the wall portion of the vibrating apparatus in the embodiment of FIG. 6 provided with a covering.

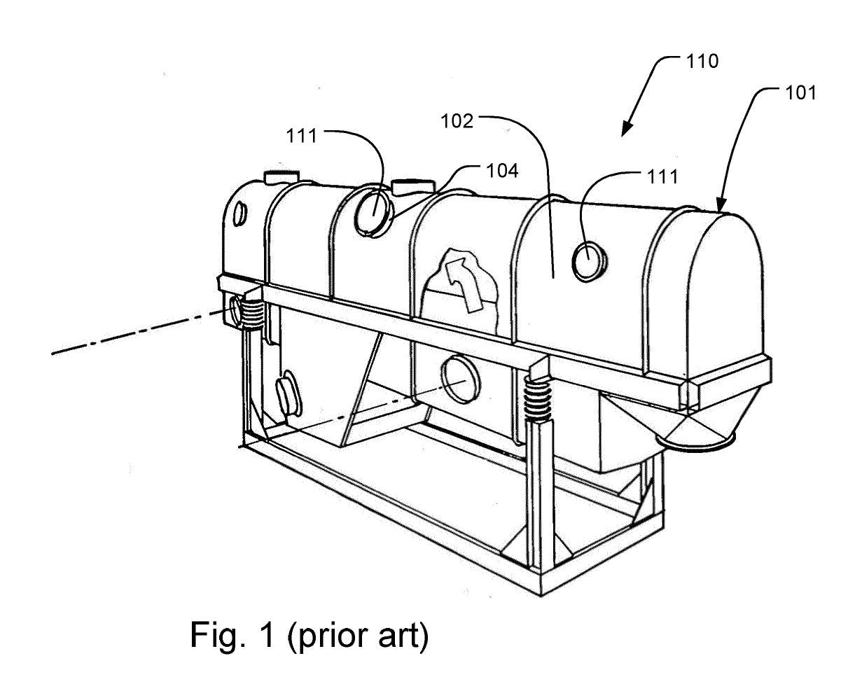

Referring initially to FIG. 1 showing a prior art vibrating apparatus in the form of a vibrating fluid bed, having a housing 101, the housing further having a wall 102. On the wall at least one covering 111 is seen, attached to a peripheral flange 104. In this embodiment, the peripheral flange 104 is welded to the wall 102.

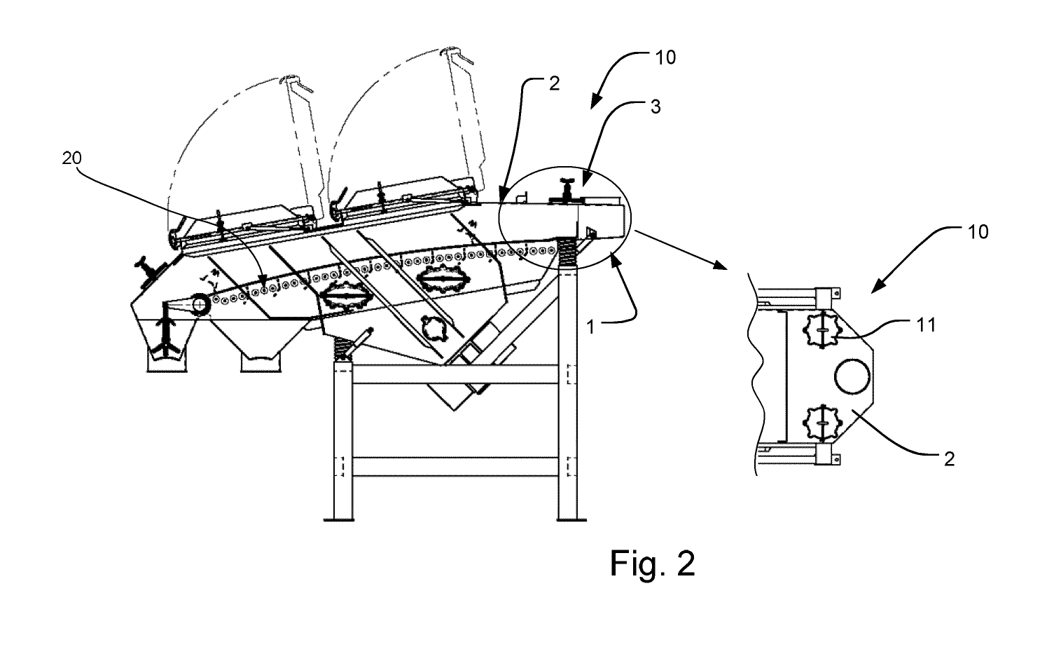

In FIG. 2, an embodiment of the invention is shown. Here a vibrating apparatus 10 is seen in the form of a vibrating sieve apparatus, the vibrating apparatus is represented by a housing 1. The housing 1 is showing a top wall, which is denoted by reference numeral 2, on which an aperture 3 is covered by a covering 11. In a manner known per se the vibrating apparatus 10 is provided with a perforated element 20 for allowing passage of material or gas such as air.

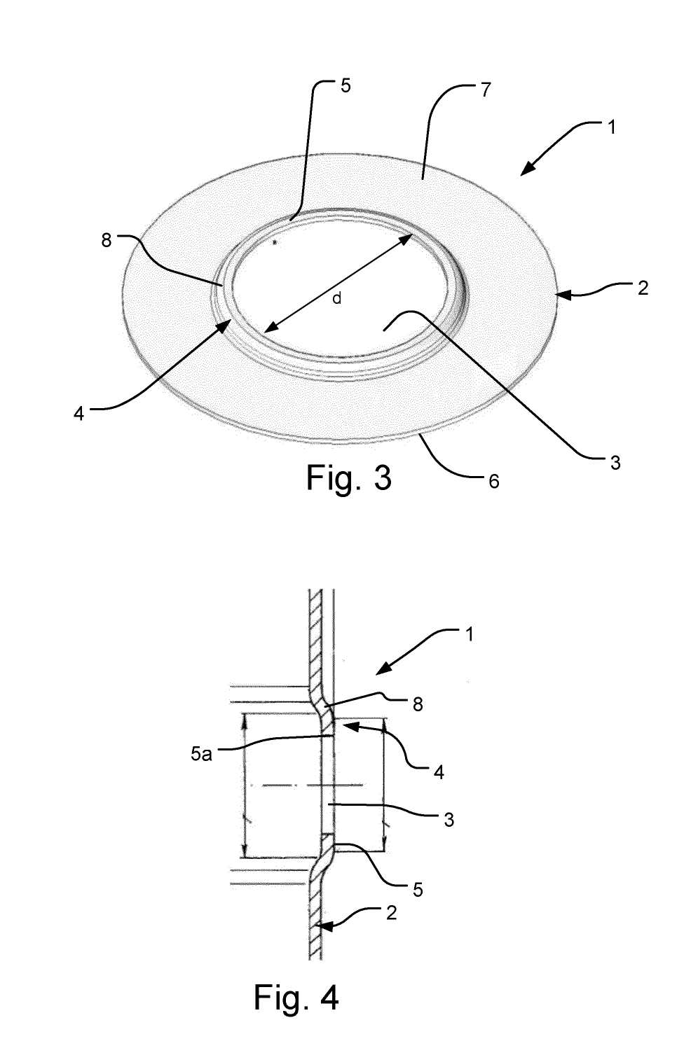

Referring to FIG. 3 showing one embodiment of a vibrating apparatus 10 according to the invention, the vibrating apparatus is represented by a housing 1. The housing 1 comprises at least one wall, typically including a top wall, a bottom wall and side walls, and a portion of one wall.

Such a vibrating apparatus is known in the art, and one example is described in Applicant's international application published under No. WO 2016/037620 A1.

Elements having the same or analogous function will be denoted by the same reference numerals throughout the description.

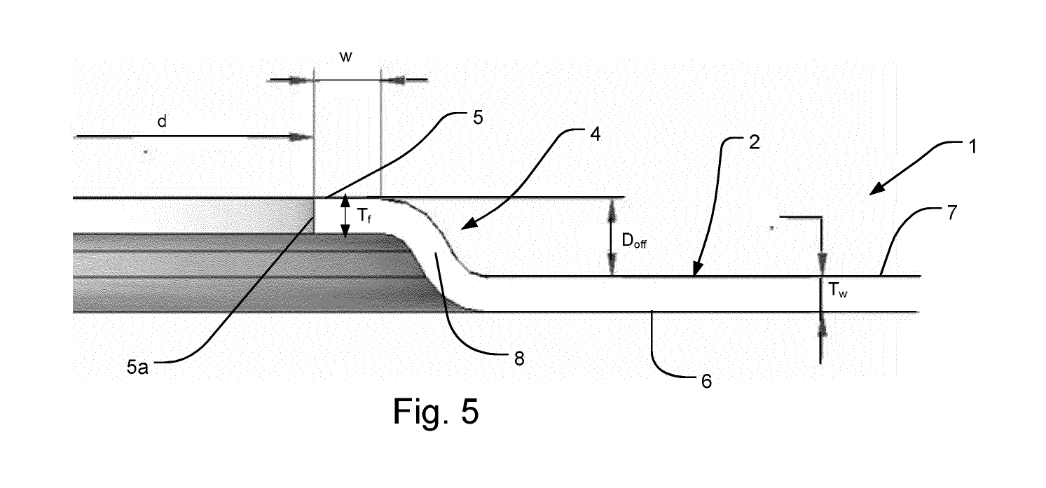

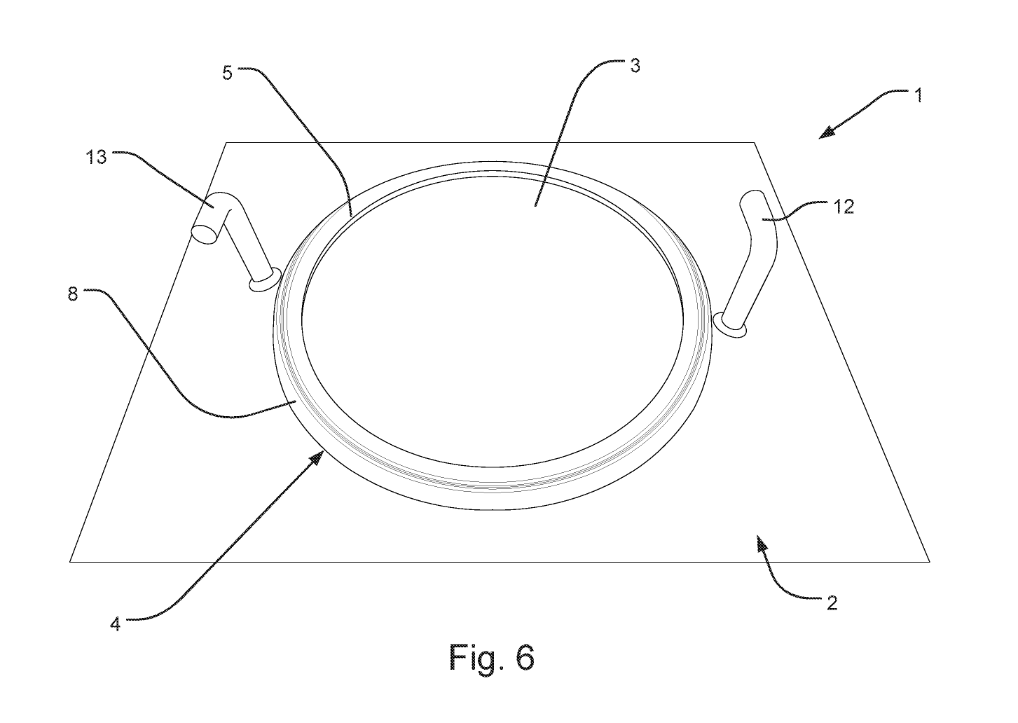

The housing 1 defines the interior of the vibrating apparatus and hence the wall 2 has an internal surface 6 facing the interior, and an exterior surface 7 facing the surroundings of the vibrating apparatus and from which access, either visual or physical or both, to the interior is desired. To that end, the wall 2 is provided with an aperture 3 and a peripheral flange 4 surrounding the aperture 3 and configured to cooperate with a covering to be described in further detail below in connection with the embodiment of FIGS. 5 and 6.

The flange 4 protrudes from the wall 2 in a direction toward the external environment, and away from the interior of the housing 1. It is conceivable that the protrusion provided by the peripheral flange may be towards the inner parts of the housing structure on the internal surface of the wall.

The protruding peripheral flange 4 has an inclined portion 8 that extends toward the exterior environment thereby creating a distance or offset to the wall 2. The extension of the inclined portion 8 of the protruding peripheral flange 4 parallel to the first plane should be understood as to define an offset distance from the wall 2 as will be described in detail below. At a maximum distance the peripheral flange 4 is provided with a plane surface 5 extending in a second plane substantially perpendicular to the first plane. In the embodiment shown, the second plane is substantially parallel to the wall 2.

The plane surface 5 forms an abutment for a covering to be connected, thereby creating a sealing surface between the wall 2 and the covering. Thus, when a covering is in a closed position, the aperture 3 is covered such that the exterior surroundings are protected from powders or minerals processed in the vibrating apparatus.

In this particular embodiment the aperture 3 has a rounded shape, namely substantially circular, wherein the size of the opening is defined as the diameter d of the aperture 3. The diameter is defined by the distance from one point at the inner edge 5a of the plane surface 5 (cf. FIGS. 4 and 5) on the peripheral flange 4 through the centre point of the aperture 3 to another point on the peripheral flange, which is opposite to the first point. In further details, a point may be defined as an inner edge point on the plane surface, wherein the inner edge 5a is defined as the edge which is the edge nearest to centre point of the aperture 3. It is within the inventive concept of the present invention that diameter d is at least 100 mm, more preferably at least 200 mm and even more preferably at least 400 mm.

As further illustrated in FIG. 4, the aperture 3 has a centre axis, which is substantially perpendicular to the plane surface 5 of the peripheral flange 4. In more detail, illustrated in FIG. 5, the dimensions of the flange 4 relative to the wall 2 will be described in some detail.

As illustrated in the Figure, the peripheral flange 4 and the wall 2 have a flange thickness T_{f} and a wall thickness T_{w}, respectively. Even though the flange 4 and the wall 2 are shown with substantially the same thickness, it should be understood that the flange thickness may be different from the wall thickness. That is, during and after the metal forming of the metal sheet defining the housing wall 2, the flange thickness T_{f} and the wall thickness T_{w} may differ. Preferably the thickness and is at least 2 mm, preferably at least 3 mm and even more preferably at least 4 mm in thickness. However, preferably the resulting difference in thickness between the flange thickness T_{f} and the wall thickness T_{w} is less than 10%, wherein it should be understood the flange thickness is smaller than the wall thickness.

The smooth inclination of the inclined portion 8 further transits into the plane surface 5 surrounding the aperture 3 in the wall 2 of the housing 1 of the vibrating apparatus 10. The protruding peripheral flange 4 is provided such that the plane surface 5 is offset from the wall 2, with an offset distance D_{off}. The offset distance D_{off} should thus be understood as the offset from the wall 2 in a direction along the centre axis of the aperture 3, the offset distance is at least 3 mm, preferably at least 6 mm and even more preferably at least 9 mm.

The plane surface 5 has a width w, which is defined as the distance between the inner edge 5a of the plane surface 5 and the transition to the inclined portion 8. Thus, in the embodiment shown the plane surface 5 is substantially also parallel to the surface of the wall 2. The width w of the plane surface 5 defines the abutment to which a covering is intended to connect when closing off the aperture 3 in the wall 2. The plane surface 5 should preferably be such that the abutment formed is able to seal the covering efficiently during operation of the vibrating apparatus. Preferably the plane surface is provided with a width w of at least 4 mm, preferably at least 7 mm, and even more preferably at least 10 mm.

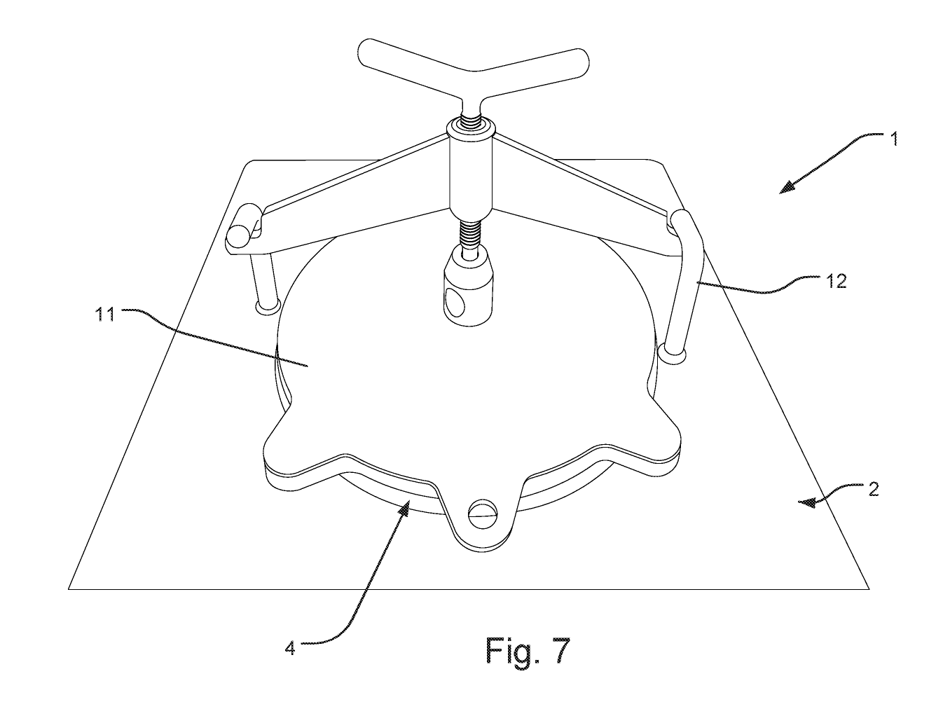

In FIGS. 6 and 7, an embodiment of the vibrating apparatus according to industrial use is illustrated as represented by the wall 2 of the housing of the vibrating apparatus. Here the protruding peripheral flange 4 has been formed from a wall 2 of the vibrating apparatus. It is seen how the flange 4 is formed in the periphery of an aperture 3. The protruding flange comprises a plane surface 5, defining an abutment surface on the inner side thereof. As illustrated more clearly in FIG. 7, the abutment surface of plane surface 5 is configured to cooperate with a covering 11. For connecting with the covering 11, the wall 2 is furthermore provided with engagement means 12, 13. The covering 11 is for instance intended to be used as an inspection cover attached to the housing 1 of the vibrating apparatus during operation of the vibrating apparatus. The covering 11 closes and seals off the aperture 3 by abutting the plane portion 5 of the peripheral flange 4.

In general, the shaping of the aperture 3 in the wall 2 could be provided in any form suitable for use in vibrating apparatus and the covering should be shaped so as to fit the aperture providing a closing thereof. Furthermore, each wall 2 in a housing 1 of a vibrating apparatus could be provided with more apertures of this kind, and that the apertures could be provided in the same or different shapes and sizes.

The wall 2 provided with the aperture 3 and the surrounding flange 4 could either form the entire wall of the housing, i.e. typically one of the side walls or the top wall, or constitute a wall section to be connected to other wall sections.

In the following, a method for improving the durability of a vibrating apparatus as described in the above will be described in some detail.

In a step A, a sheet of metal for a housing wall part is provided. This sheet could have any size, but preferably has a thickness of at least 2 mm, more preferably at least 3 mm, and even more preferably at least 4 mm.

A target section is chosen somewhere on the sheet of metal, and this target section, is where the aperture and offset peripheral flange of the first aspect of the invention are formed in the following steps of the method.

In step B of the method, the sheet of metal is placed in a press form, by placing a target section of the sheet of metal in a recess of a bottom part of the form, In other embodiments, the can be other ways to place the target section in a specific area of the press.

In a specific embodiment, a plate is fastened to the sheet of metal and the bottom part of the form. In a further embodiment, a top part of the form is fastened to the plate and the bottom part of the form.

In step C of the method, the top part of the form is pressed by mechanical means to form an offset plane surface,

In an embodiment, where the aperture is cut prior to step C, the offset flange is formed in step C. In another embodiment, wherein the aperture is cut after step C, a protrusion is formed at the target section in the sheet of metal.

The method further comprises the step of cutting an aperture in said target section of the sheet of metal, by drilling, punching, sawing, cutting, milling of lathing or other like methods. This step can be performed following any of the steps, thus providing the aperture with an offset peripheral flange bordering the aperture, once all steps have been performed.

Variations to the method are conceivable. As one example, it is possible to provide a separate plate and fasten the plate on the sheet of metal and the bottom part of the form following step B. The top part of the form is then fastened to the plate and the bottom part of the form, following which step C is carried out,

In general, the description of the advantageous embodiments as described throughout the description should also be understood as to apply for the method for forming a peripheral flange around an aperture in a wall of a vibrating apparatus.

The invention should not be regarded as being limited to the embodiments shown and described in the above. Several modifications and combinations are conceivable within the scope of the appended claims. Although the invention has been described with reference to a vibrating apparatus having a substantially rectangular configuration, the underlying principle is applicable to apparatus having other configurations such as for instance circular.

1. A vibrating apparatus comprising:
a housing including at least one wall provided with at least one aperture having a center axis,
a peripheral flange which protrudes from the wall at the aperture and is configured to cooperate with a covering, wherein the peripheral flange includes a plane surface for abutment of the covering, the plane surface extending in a plane, the center axis being perpendicular to the plane,
the peripheral flange formed as an integral part of the wall and from the wall material itself,
the peripheral flange comprising an inclined portion that extends toward an exterior environment thereby creating a distance or an offset to the wall,
wherein the plane surface of the peripheral flange is offset from the wall in a direction along the center axis of the aperture,
the plane surface having a width defined as a first distance between an inner edge of the plane surface and a transition to the inclined portion,
the aperture having a minimum opening or diameter, measured as a second distance from a first point at the inner edge of the plane surface on the peripheral flange through a center point of the aperture to a second point on the peripheral flange, the second point being opposite the first point,
the inner edge being an edge nearest to the center point of the aperture.

2. The vibrating apparatus according to claim 1, wherein the vibrating apparatus further comprises a perforated element for allowing passage of material or gas such as air.

3. The vibrating apparatus according to claim 2, wherein the vibrating apparatus is a vibrating sieve apparatus or a vibrating fluid bed.

4. The vibrating apparatus according to claim 1, wherein the peripheral flange has been formed by sheet metal forming, such as drawing, pressing, pulling, rolling, or punching.

5. The vibrating apparatus according to claim 1, wherein the peripheral flange and the wall have a thickness of at least 2 mm.

6. The vibrating apparatus according to claim 1, wherein the plane surface of the peripheral flange has a width (w) of at least 4 mm.

7. The vibrating apparatus according to claim 1, wherein the aperture has a shape chosen from a group of geometrical shapes including round, elliptical, square, and rectangular.

8. The vibrating apparatus according to claim 1, wherein the aperture has a minimum opening, measured as the second distance from the first point on the peripheral flange through the center point of the aperture to the second point on the peripheral flange, the minimum opening being at least 100 mm.

9. The vibrating apparatus according to claim 1, wherein the plane surface of the peripheral flange is offset from the wall in a direction along the center axis of the aperture, by at least 3 mm.

10. A method for improving the durability of a vibrating apparatus by forming a cover frame in a wall of a housing of the vibrating apparatus, said method comprising:
providing a sheet of metal for a housing wall part;
placing the sheet of metal in a press form, by placing a target section of the sheet of metal in a recess of a bottom part of the press form;
mechanically pressing a top part of the form to form an offset plane surface; and
cutting an aperture in the target section of the sheet of metal, by drilling, punching, sawing, cutting, or milling of lathing, such that the aperture has an offset peripheral flange bordering the aperture,
wherein the offset peripheral flange is formed as an integral part of the sheet of metal and the offset peripheral flange is formed from the sheet of metal itself,
the offset peripheral flange comprising an inclined portion that extends toward an exterior environment thereby creating a distance or an offset to the remainder of the sheet of metal,
wherein a plane surface of the offset peripheral flange is offset from a remainder of the sheet of metal in a direction along a center axis of the aperture,
the plane surface having a width defined as a first distance between an inner edge of the plane surface and a transition to the inclined portion,
the aperture has a minimum opening or diameter, measured as a second distance from a first point at the inner edge of the plane surface on the peripheral flange through a center point of the aperture to a second point on the peripheral flange, which is opposite the first point,
the inner edge being the edge nearest to the center point of the aperture.

11. The method according to claim 10 wherein the sheet of metal is stainless steel.

12. The method according to claim 10 wherein the sheet of metal is at least 300 mm by 300 mm.

13. The method according to claim 10, wherein the sheet of metal has a thickness of at least 2 mm.

14. The method according to claim 10, wherein the sheet of metal has a reduction in thickness of less than 10% as a result of the pressing.

15. The method according to claim 10, wherein the plane surface of the offset peripheral flange has a width of at least 4 mm.

16. The method according to claim 10, wherein the aperture is cut with a minimum opening, the minimum opening measured as the second distance from one point on the cut through the center point of the aperture to another point on the cut, the minimum opening being at least 100 mm.

17. The method according to claim 10, wherein the plane surface of the target section is offset from the wall in a direction along the center axis of the aperture, by at least 3 mm.

18. A vibrating apparatus comprising:
a housing including at least one wall provided with at least one aperture having a center axis,
a peripheral flange which protrudes from the wall at the aperture and is configured to cooperate with a covering, wherein the peripheral flange includes a plane surface that is configured to abut the covering, the plane surface extending in a plane, the center axis being perpendicular to the plane,
the peripheral flange formed as an integral part of the wall and from the wall material itself,
the peripheral flange comprising an inclined portion that extends toward an exterior environment thereby creating a distance or an offset to the wall,
wherein the plane surface of the peripheral flange is offset from the wall in a direction along the center axis of the aperture,
the plane surface having a width defined as the distance between an inner edge of the plane surface and a transition to the inclined portion,
the aperture having a minimum opening or diameter, measured as the distance from a first point at the inner edge of the plane surface on the peripheral flange through the center point of the aperture to a second point on the peripheral flange, the second point being opposite the first point,
the inner edge being an edge nearest to the center point of the aperture.

19. The vibrating apparatus according to claim 18, further comprising a perforated element that is configured to allow passage of material or gas such as air.
